(19) United States
(12) Patent Application Publication
(10) Pub. No.: US 2026/0319722 A1
(43) Pub. Date: Oct. 15, 2026

(54) ARRANGEMENT MANAGEMENT APPARATUS, ARRANGEMENT MANAGEMENT METHOD, AND NON-TRANSITORY RECORDING MEDIUM

(71) Applicant: Yuki Sugano, Kanagawa (JP)

(72) Inventor: Yuki Sugano, Kanagawa (JP)

(73) Assignee: Ricoh Company, Ltd., Tokyo (JP)

(21) Appl. No.: 19/567,924

(22) Filed: Mar. 16, 2026

(30) Foreign Application Priority Data
Mar. 25, 2025 (JP) 2025-049217

(51) Int. Cl. G06F 3/12

(52) U.S. Cl. CPC G06F 3/1264; G06F 3/1205

(57) ABSTRACT

An arrangement management apparatus includes circuitry to receive, from a first terminal apparatus, a selection of a job from a list of a plurality of jobs being displayed on the first terminal apparatus, each job for producing products and at least a part of settings of processing conditions for the selected job, request, after the selection of the job is received, a second terminal apparatus to arrange a material used for executing the job, and transmit, to the first terminal apparatus, a notification indicating that preparation of the material for use is completed.

### CROSS-REFERENCE TO RELATED APPLICATIONS

This patent application is based on and claims priority pursuant to 35 U.S.C. § 119(a) to Japanese Patent Application No. 2025-049217, filed on Mar. 25, 2025, in the Japan Patent Office, the entire disclosure of which is hereby incorporated by reference herein.

### BACKGROUND

### Technical Field

The present disclosure relates to an arrangement management apparatus, an arrangement management method, and a non-transitory recording medium.

### Related Art

Some techniques have been proposed relating to inventory management of sheets, such as printing paper, used for print jobs executed in a working environment such as a printing factory. For example, a technique has been proposed relating to an image forming apparatus that searches for an inventory corresponding to sheet information of paper stored in a sheet feeding tray from an inventory management system and displays inventory information relating to the searched inventory.

### SUMMARY

The present disclosure described herein provides an arrangement management apparatus including circuitry to receive, from a first terminal apparatus, a selection of a job from a list of a plurality of jobs being displayed on the first terminal apparatus, each job for producing products and at least a part of settings of processing conditions for the selected job, request, after the selection of the job is received, a second terminal apparatus to arrange a material used for executing the job, and transmit, to the first terminal apparatus, a notification indicating that preparation of the material for use is completed.

The present disclosure described herein further provides an arrangement management method including receiving, from a first terminal apparatus, a selection of a job from a list of a plurality of jobs being displayed on the first terminal apparatus, each job for producing products and at least a part of settings of processing conditions for the selected job, requesting, after the selection of the job is received, a second terminal apparatus to arrange a material used for executing the job, and transmitting, to the first terminal apparatus, a notification indicating that preparation of the material for use is completed.

The present disclosure described herein further provides a non-transitory recording medium storing a plurality of program codes which, when executed by one or more processors, causes the one or more processors to perform a method including receiving, from a first terminal apparatus, a selection of a job from a list of a plurality of jobs being displayed on the first terminal apparatus, each job for producing products and at least a part of settings of processing conditions for the selected job, requesting, after the selection of the job is received, a second terminal apparatus to arrange a material used for executing the job, and transmitting, to the first terminal apparatus, a notification indicating that preparation of the material for use is completed.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an overall configuration of an arrangement management system;

FIG. 2 is a block diagram illustrating a hardware configuration of each of an arrangement management apparatus and an order receipt item management server;

FIG. 3 is a block diagram illustrating a hardware configuration of each of a printing staff terminal apparatus, a manager terminal apparatus, a cutting staff terminal apparatus, and a sales staff terminal apparatus;

FIG. 4 is a block diagram illustrating a functional configuration of an arrangement management system;

FIG. 5 is a diagram illustrating an example of order receipt item data;

FIG. 6 is a diagram illustrating an example of sheet arrangement item data;

FIG. 7 is a diagram illustrating transitions of screens displayed by a printing staff terminal apparatus at a time of sheet arrangement;

FIG. 8 is a diagram illustrating transitions of screens displayed by a manager terminal apparatus at a time of sheet arrangement;

FIG. 9 is a diagram illustrating transitions of screens displayed by a cutting staff terminal apparatus at a time of cutting sheets and preparing the sheets for use;

FIG. 10 is a sequence diagram illustrating a process to request sheet arrangement in an arrangement management system;

FIG. 11 is a sequence diagram illustrating a process to order sheets in an arrangement management system;

FIG. 12 is a sequence diagram illustrating a process to prepare sheets for use in an arrangement management system; and

FIG. 13 is a flowchart of an arrangement management method performed by an arrangement management apparatus.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

For the sake of simplicity, identical or similar reference numerals denote identical or similar elements such as parts and materials having the same functions, and redundant descriptions thereof are omitted unless otherwise required.

### Configuration of Arrangement Management System

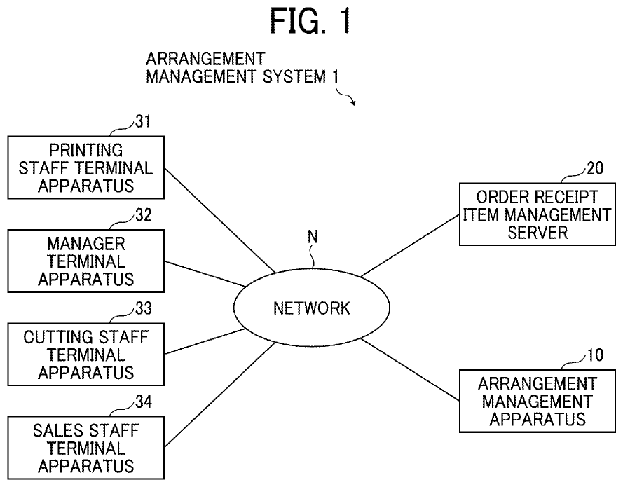

FIG. 1 is a diagram illustrating an overall configuration of an arrangement management system 1. In the arrangement management system 1, an arrangement management apparatus 10, an order receipt item management server 20, a printing staff terminal apparatus 31, a manager terminal apparatus 32, a cutting staff terminal apparatus 33, and a sales staff terminal apparatus 34 are communicably connected. The arrangement management system 1 includes one apparatus for each type of the terminal apparatuses, but may include a plurality of apparatuses for each type.

The arrangement management system 1 is a system for managing arrangement of materials used for jobs in a work environment. In the following description, the arrangement management system 1 is described by taking a print job as an example of a job for producing a product. In addition, a sheet on which an image is printed is described as an example of a material used for executing the job. The sheet is a medium on which an image is formed, such as paper or a sheet material. In the following description, the sheet is also referred to as “paper” or “a sheet of paper” where appropriate. The product is a sheet on which an image is formed by printing. The work environment is an environment where the print job is executed and is provided with, for example, an image forming apparatus and a storage place for sheets. The work environment may include a space in which the sheets are cut. The working environment, the product, and the material are not limited to the examples described above.

The arrangement management apparatus 10, the order receipt item management server 20, the printing staff terminal apparatus 31, the manager terminal apparatus 32, the cutting staff terminal apparatus 33, and the sales staff terminal apparatus 34 are connected to one another via a network N. The network N is implemented by, for example, a wired communication network such as the Internet, a local area network (LAN), or a wide area network (WAN). The network N may alternatively be implemented by a wireless communication network using, for example, a wireless LAN access point, short-range wireless communication such as Bluetooth^{®} or the near field communication (NFC), or Wireless Fidelity (Wi-Fi^{®}).

A sales staff member inputs job information of a print job, for which an order has been received, on a screen displayed on the display of the sales staff terminal apparatus 34. The sales staff terminal apparatus 34 transmits the job information to the order receipt item management server 20. The order receipt item management server 20 receives the information and stores items included in the information as order receipt item data, which is an example of a list of print jobs. A printing staff member uses the printing staff terminal apparatus 31 to access the order receipt item management server 20 and enters a part of processing conditions for a selected print job on the displayed screen. The printing staff terminal apparatus 31 transmits those processing conditions to the arrangement management apparatus 10. The arrangement management apparatus 10 receives those processing conditions and stores items included in those processing conditions as sheet arrangement item data.

After receiving a selection of a print job from the printing staff terminal apparatus 31, the arrangement management apparatus 10 requests the manager terminal apparatus 32 to arrange sheets used for the execution of the print job. In response to receiving an approval for the execution of the print job from the manager terminal apparatus 32, the arrangement management apparatus 10 creates an order form for the sheets and transmits the created order form to, for example, a supplier. The arrangement management apparatus 10 transmits, to the cutting staff terminal apparatus 33, a notification relating to a request for preparing the sheets to be used for the execution of the print job. The arrangement management apparatus 10 transmits, to the printing staff terminal apparatus 31, a notification indicating that the preparation of the sheets for use is completed. Then, the print job is executed.

The order receipt item management server 20 is an apparatus for managing a print job for which an order has been received. The job information of the print job for which the order has been received is input from the sales staff terminal apparatus 34 to the order receipt item management server 20. The order receipt item management server 20 stores the print job for which the order has been received as the order receipt item data that is an example of the list of print jobs. The contents of the order receipt item data are displayed on, for example, the display of the printing staff terminal apparatus 31 by accessing the order receipt item management server 20.

The printing staff terminal apparatus 31 displays the order receipt item data that is input from the sales staff terminal apparatus 34 to the order receipt item management server 20. The order receipt item data can be displayed by accessing the order receipt item management server 20. The printing staff member uses the printing staff terminal apparatus 31 to select a print job to be executed.

The printing staff member uses the printing staff terminal apparatus 31 to set and confirm the details of the contents of sheet arrangement including the processing conditions of the job for the selected print job, and register the sheet arrangement in the arrangement management apparatus 10. The arrangement management apparatus 10 transmits a request for approving the execution of the print job to the manager terminal apparatus 32. When the execution of the print job is approved and the preparation of the sheets is completed, the printing staff terminal apparatus 31 receives a notification indicating that the preparation of the sheets for use is completed from the arrangement management apparatus 10.

The manager terminal apparatus 32 displays a list of print jobs for which the printing staff terminal apparatus 31 transmits requests for approval via the arrangement management apparatus 10. The manager terminal apparatus 32 receives an operation for approving one of the displayed print jobs and transmits information on the approved print job to the arrangement management apparatus 10. The arrangement management apparatus 10 transmits the order form for the sheets to, for example, a supplier, and also transmits an instruction to cut the sheets to the cutting staff terminal apparatus 33.

The cutting staff terminal apparatus 33 receives, from the arrangement management apparatus 10, the instruction to cut the sheets to be used for executing the approved print job. After the completion of the sheet cutting, the cutting staff terminal apparatus 33 transmits, to the arrangement management apparatus 10, a notification indicating that the preparation of the sheets for use is completed. Then, the arrangement management apparatus 10 transmits, to the printing staff terminal apparatus 31, the notification indicating that the preparation of the sheets for use is completed.

The sales staff terminal apparatus 34 transmits the job information of the print job for which the order has been received to the order receipt item management server 20. The input print job is stored in the order receipt item management server 20 as the order receipt item data.

The arrangement management apparatus 10 performs the creation of the order form for the sheets and the transmission of the order form to, for example, the supplier. Alternatively, the printing staff terminal apparatus 31 may perform the creation and the transmission. The arrangement management apparatus 10 performs the transmission of the order form for the sheets. Alternatively, the manager terminal apparatus 32 may perform the transmission. The arrangement management apparatus 10 performs the notification relating to the preparation of the sheets for use. Alternatively, the cutting staff terminal apparatus 33 may perform the notification.

The configuration of the arrangement management system 1 is not limited to that illustrated in FIG. 1. For example, the arrangement management system 1 may include a single server apparatus provided with the functions of the arrangement management apparatus 10 and the order receipt item management server 20. Also, the arrangement management system 1 includes four terminal apparatuses such as the printing staff terminal apparatus 31, the manager terminal apparatus 32, the cutting staff terminal apparatus 33, and the sales staff terminal apparatus 34. However, the number of the terminal apparatuses may not be four. The number and types of terminal apparatuses may be included as desired. For example, the arrangement management system 1 may include two printing staff terminal apparatuses 31 and one terminal apparatus in which the printing staff terminal apparatus 31 and the sales staff terminal apparatus 34 are integrated.

The printing staff terminal apparatus 31 is an example of a first terminal apparatus. The manager terminal apparatus 32 is an example of a second terminal apparatus. The cutting staff terminal apparatus 33 is an example of a third terminal apparatus. The sales staff terminal apparatus 34 is an example of a fourth terminal apparatus.

### Hardware Configuration

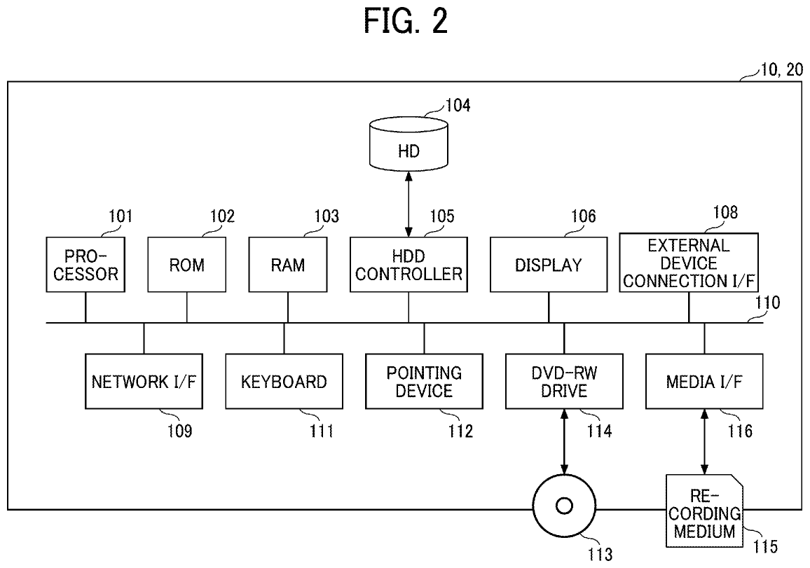

FIG. 2 is a block diagram illustrating a hardware configuration of each of the arrangement management apparatus 10 and the order receipt item management server 20. The hardware configuration of each of the arrangement management apparatus 10 and the order receipt item management server 20 is not limited to that illustrated in FIG. 2.

As illustrated in FIG. 2, each of the arrangement management apparatus 10 and the order receipt item management server 20 is implemented by a computer. Each of the arrangement management apparatus 10 and the order receipt item management server 20 includes a processor 101, a read-only memory (ROM) 102, a random-access memory (RAM) 103, a hard disk (HD) 104, a hard disk drive (HDD) controller 105, a display 106, an external device connection interface (I/F) 108, a network I/F 109, a data bus 110, a keyboard 111, a pointing device 112, a digital versatile disc-rewritable (DVD-RW) drive 114, and a media I/F 116.

The processor 101 corresponds to the central part of the computer. The processor 101 controls various components to implement functions as the arrangement management apparatus 10 or the order receipt item management server 20 to which the processor 101 belongs according to an operating system or an application program. The processor 101 includes various arithmetic devices such as a central processing unit (CPU) and a graphics processing unit (GPU). The processor 101 is a multi-core processor that includes multiple processor cores and can execute multiple processes in parallel. The processor 101 reads out various programs onto the RAM 103 and executes the programs.

The ROM 102 stores a program such as an initial program loader (IPL) used for booting the processor 101. The RAM 103 is used as a work area for the processor 101. The HD 104 stores various data such as a program.

The HDD controller 105 controls the reading of various data from, or the writing of various data to, the HD 104 under the control of the processor 101. The display 106 displays various types of information, such as a cursor, a menu, a window, text, or an image. The external device connection I/F 108, which may be implemented by an interface circuit, is an interface for connection with various external devices. Examples of the external devices in this case include, but are not limited to, a universal serial bus (USB) memory and a printer. The network I/F 109, which may be implemented by an interface circuit, is an interface for data communication through the communication network N. The data bus 110 is, for example, an address bus or a data bus, which electrically connects the components or elements such as the processor 101.

The keyboard 111 is an example of an input device provided with multiple keys used for inputting characters, numerical values, and various instructions. The pointing device 112 is an example of an input device that allows selection or execution of various instructions, selection of a processing target, and movement of a cursor. The DVD-RW drive 114 controls the reading of various data from, or the writing of various data to, a DVD-RW 113, which is an example of a removable recording medium. The removable recording medium is not limited to a DVD-RW and may be, for example, a digital versatile disc recordable (DVD-R). The media I/F 116 controls the reading of data from, or the writing (storing) of data to (in), a recording medium 115 such as a flash memory.

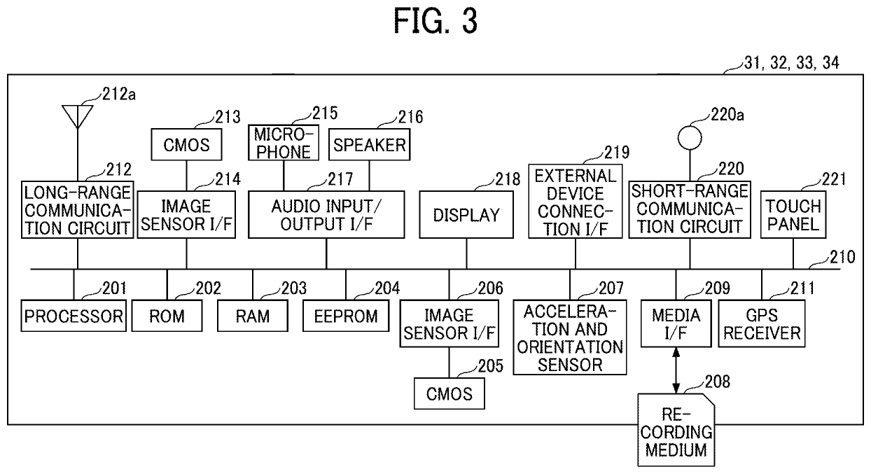

FIG. 3 is a block diagram illustrating a hardware configuration of each of the printing staff terminal apparatus 31, the manager terminal apparatus 32, the cutting staff terminal apparatus 33, and the sales staff terminal apparatus 34. The hardware configuration of each of the printing staff terminal apparatus 31, the manager terminal apparatus 32, the cutting staff terminal apparatus 33, and the sales staff terminal apparatus 34 is not limited to that illustrated in FIG. 3.

As illustrated in FIG. 3, each of the printing staff terminal apparatus 31, the manager terminal apparatus 32, the cutting staff terminal apparatus 33, and the sales staff terminal apparatus 34 includes a processor 201, a ROM 202, a RAM 203, an electrically erasable programmable read-only memory (EEPROM) 204, a complementary metal oxide semiconductor (CMOS) sensor 205, an image sensor I/F 206, an acceleration and orientation sensor 207, a media I/F 209, and a global positioning system (GPS) receiver 211.

The processor 201 controls various components to implement functions as the terminal apparatus according to an operating system or an application program. The processor 201 includes various arithmetic devices such as a CPU and a GPU. The processor 201 is a multi-core processor that includes multiple processor cores and can execute multiple processes in parallel. The processor 201 reads out various programs onto the RAM 203 and executes the programs.

The ROM 202 stores a program such as an IPL used for booting the processor 201. The RAM 203 is used as a work area for the processor 201. The EEPROM 204 reads or writes various data such as a program for a smartphone under the control of the processor 201.

The CMOS sensor 205 is an example of a built-in imaging device that captures an image of a subject under the control of the processor 201 to obtain image data. Instead of the CMOS sensor, an imaging device such as a charge-coupled device (CCD) sensor may be used. The image sensor I/F 206 is a circuit that controls the driving of the CMOS sensor 205. The acceleration and orientation sensor 207 includes various sensors, such as an electromagnetic compass or gyrocompass for detecting geomagnetism and an acceleration sensor. The media I/F 209 controls the reading of data from, or the writing (storing) of data to (in), a recording medium 208 such as a flash memory. The GPS receiver 211 receives a GPS signal from a GPS satellite.

Each of the printing staff terminal apparatus 31, the manager terminal apparatus 32, the cutting staff terminal apparatus 33, and the sales staff terminal apparatus 34 includes a long-range communication circuit 212, an antenna 212a for the long-range communication circuit 212, a CMOS sensor 213, an image sensor I/F 214, a microphone 215, a speaker 216, an audio input/output I/F 217, a display 218, an external device connection I/F 219, a short-range communication circuit 220, an antenna 220a for the short-range communication circuit 220, and a touch panel 221.

The long-range communication circuit 212 is a circuit for communicating with other devices via the communication network N. The CMOS sensor 213 is an example of a built-in imaging device that captures an image of a subject under the control of the processor 201 to obtain image data. The image sensor I/F 214 is a circuit that controls the driving of the CMOS sensor 213. The microphone 215 is a built-in circuit that converts sound into electrical signals. The speaker 216 is a built-in circuit that converts electrical signals into physical vibration to produce sound such as music or voice. The audio input/output I/F 217 is a circuit that processes the input and output of audio signals between the microphone 215 and the speaker 216 under the control of the processor 201.

The display 218 is an example of a display that displays an image of a subject and various icons, and may be implemented by, for example, a liquid crystal display or an organic electro-luminescence (EL) display. The external device connection I/F 219, which may be implemented by an interface circuit, is an interface for connection with various external devices. The short-range communication circuit 220 is a communication circuit in compliance with a communication protocol such as the NFC or Bluetooth^{®}. The touch panel 221 is an example of an input device that allows a user to operate the terminal apparatus by touching or pressing a screen of the display 218.

Each of the printing staff terminal apparatus 31, the manager terminal apparatus 32, the cutting staff terminal apparatus 33, and the sales staff terminal apparatus 34 includes a bus line 210. The bus line 210 is, for example, an address bus or a data bus, which electrically connects the components or elements such as the processor 201.

### Functional Configuration

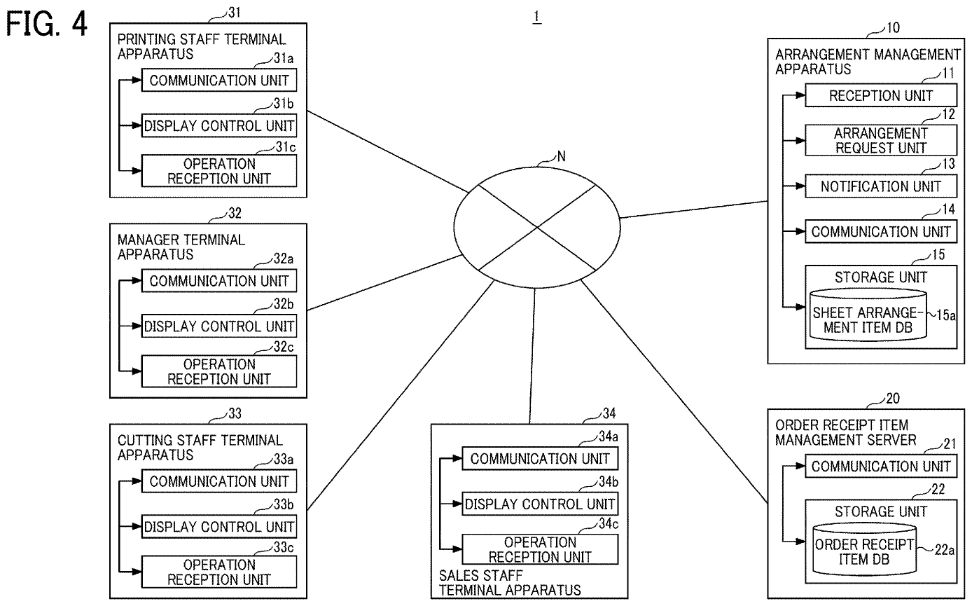

FIG. 4 is a block diagram illustrating a functional configuration of the arrangement management system 1. The functional units included in the arrangement management apparatus 10, the order receipt item management server 20, the printing staff terminal apparatus 31, the manager terminal apparatus 32, the cutting staff terminal apparatus 33, and the sales staff terminal apparatus 34 are not limited to those illustrated in FIG. 4, and other functional units may be included.

### Arrangement Management Apparatus

The arrangement management apparatus 10 includes a reception unit 11, an arrangement request unit 12, a notification unit 13, a communication unit 14, and a storage unit 15. These functional units of the arrangement management apparatus 10 are implemented by or caused to function by one or more of the hardware components illustrated in FIG. 2 operating in accordance with instructions from the processor 101 according to the control program loaded from the HD 104 to the RAM 103.

The reception unit 11 receives, from the printing staff terminal apparatus 31, a selection of a print job operated by the printing staff member from the order receipt item data displayed on the printing staff terminal apparatus 31. The printing staff member is a user of the printing staff terminal apparatus 31. The order receipt item data is an example of the list of print jobs. The printing staff terminal apparatus 31 is an example of the first terminal apparatus. The reception unit 11 also receives, from the printing staff terminal apparatus 31, at least a part of the settings of the processing conditions for the selected print job. The order receipt item data includes each item of the job information transmitted from the sales staff terminal apparatus 34 to the order receipt item management server 20, and is stored in the order receipt item management server 20. The sales staff terminal apparatus 34 is an example of the fourth terminal apparatus. The processing conditions for the print job are formed of inputs from the printing staff terminal apparatus 31 and the order receipt item data. The processing conditions are stored in the storage unit 15.

After receiving the selection of the print job from the printing staff terminal apparatus 31, the arrangement request unit 12 requests the manager terminal apparatus 32, which is an example of the second terminal apparatus, to arrange sheets used for executing the print job. The arrangement request unit 12 requests the arrangement of the sheets based on information on the number of sheets to be used for the selected print job.

More specifically, the arrangement request unit 12 requests the arrangement of the sheets based on level information included in the processing conditions and indicating the degree of difficulty of execution for each print job and the number of spare sheets required for each selected print job. The level information is also referred to as a “print level.” The number of spare sheets is also referred to as the “number of additional spare sheets.” The number of sheets to be used for a print job is determined based on the level information of the print job. For example, when the print level is high, the number of additional spare sheets is set to be large, and when the print level is low, the number of additional spare sheets is set to be small. However, the method for determining the number of additional spare sheets is not limited to this approach.

The information on the number of sheets includes, but is not limited to, the items related to the number of sheets included in the order receipt item data stored in the order receipt item management server 20, the number of sheets included in the sheet arrangement item data, the number of cuts, and the number of additional spare sheets.

When receiving an approval for executing the print job from the manager terminal apparatus 32, the notification unit 13 transmits, to the cutting staff terminal apparatus 33, which is an example of the third terminal apparatus, a notification relating to a preparation request for preparing the sheets to be used for the execution of the print job. The notification relating to the preparation request includes, for example, an instruction of sheet cutting. After the sheet cutting is completed, the notification unit 13 transmits, to the printing staff terminal apparatus 31, a notification indicating that the preparation of the sheets for use is completed.

The communication unit 14 communicates with the printing staff terminal apparatus 31, the manager terminal apparatus 32, the cutting staff terminal apparatus 33, and the sales staff terminal apparatus 34 to exchange various information to and from each other. The communication unit 14 receives a part of the processing conditions for the print job from the printing staff terminal apparatus 31.

The storage unit 15 is implemented by, for example, the HD 104 illustrated in FIG. 2. The storage unit 15 includes a sheet arrangement item database (DB) 15a. The sheet arrangement item DB 15a stores, as the sheet arrangement item data, the items received by the communication unit 14 from the printing staff terminal apparatus 31.

### Order Receipt Item Management Server

The order receipt item management server 20 includes a communication unit 21 and a storage unit 22. These functional units of the order receipt item management server 20 are implemented by or caused to function by one or more of the hardware components illustrated in FIG. 2 operating in accordance with instructions from the processor 101 according to the control program loaded from the HD 104 to the RAM 103.

The communication unit 21 communicates with the printing staff terminal apparatus 31, the manager terminal apparatus 32, the cutting staff terminal apparatus 33, and the sales staff terminal apparatus 34 to exchange various information to and from each other. The communication unit 21 receives, from the sales staff terminal apparatus 34, the job information of the print job for which the order has been received.

The storage unit 22 is implemented by, for example, the HD 104 illustrated in FIG. 2. The storage unit 22 includes an order receipt item DB 22a. The order receipt item DB 22a stores, as the order receipt item data that is an example of the list of print jobs, the items received by the communication unit 21 from the sales staff terminal apparatus 34.

### Printing Staff Terminal Apparatus, Manager Terminal Apparatus, Cutting Staff Terminal Apparatus, and Sales Staff Terminal Apparatus

The printing staff terminal apparatus 31, the manager terminal apparatus 32, the cutting staff terminal apparatus 33, and the sales staff terminal apparatus 34 include communication units 31a, 32a, 33a, and 34a, display control units 31b, 32b, 33b, and 34b, and operation reception units 31c, 32c, 33c, and 34c, respectively.

These functional units are functions or means that are implemented by the processor 201 illustrated in FIG. 3 executing instructions included in one or more programs installed in each of the printing staff terminal apparatus 31, the manager terminal apparatus 32, the cutting staff terminal apparatus 33, and the sales staff terminal apparatus 34. A web browser is used as these programs, but a dedicated application may be used.

The communication units 31a, 32a, 33a, and 34a transmit and receive various kinds of information to and from the arrangement management apparatus 10 and the order receipt item management server 20. In the present embodiment, the communication units 31a, 32a, 33a, and 34a receive, for example, screen information of various screens from the arrangement management apparatus 10 and the order receipt item management server 20, and transmit the contents input by users of the respective terminal apparatuses to the arrangement management apparatus 10 and the order receipt item management server 20.

Each of the display control units 31b, 32b, 33b, and 34b interprets the screen information of various screens to display the screens on the display 218. Each of the operation reception units 31c, 32c, 33c, and 34c receives various operations performed by each user on the screens displayed on the display 218.

### Order Receipt Item Data

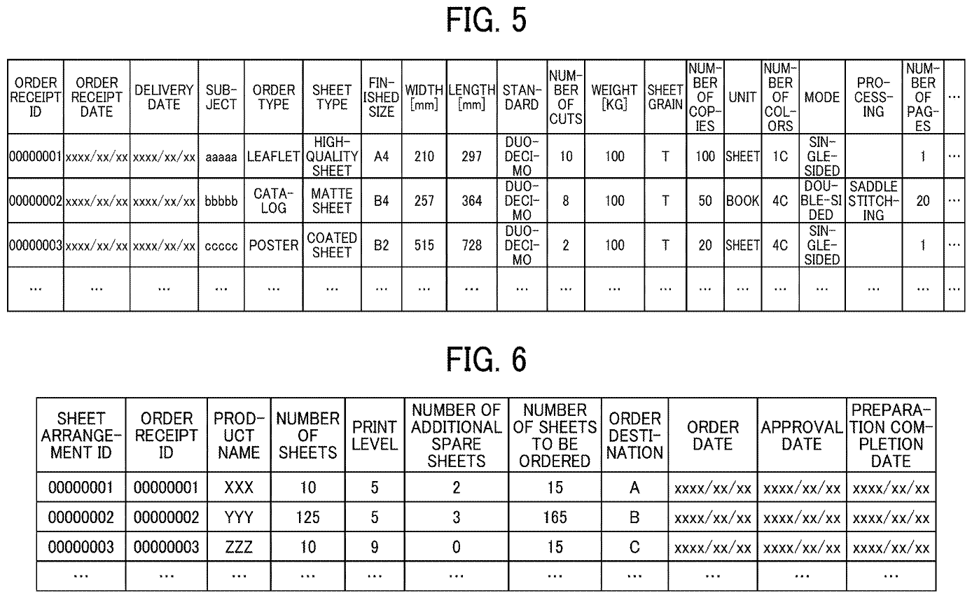

FIG. 5 is a diagram illustrating an example of the order receipt item data. The order receipt item data is an example of the list of print jobs transmitted from the sales staff terminal apparatus 34 to the order receipt item management server 20. The order receipt item data is stored in the order receipt item DB 22a of the order receipt item management server 20. The order receipt item data includes, for example, the items illustrated in FIG. 5.

In FIG. 5, an “order receipt identification (ID)” is identification information for uniquely identifying a print job, including symbols and numbers that are automatically generated when the print job is registered in the order receipt item management server 20 from the sales staff terminal apparatus 34. The rest of the items are input, from the sales staff terminal apparatus 34, by the sales staff member who is the user of the sales staff terminal apparatus 34. However, some of the rest of the items may be automatically generated.

An “order receipt date” refers to the date when the order for a print job is received. A “delivery date” refers to the date when the printed matter to be produced according to the print job is scheduled to be delivered. A “subject” refers to a subject that indicates the outline of the contents of the order receipt item. An “order type” refers to a type of the printed matter such as a leaflet, a pamphlet, or a business card. A “sheet type” refers to a type of sheet, such as a coated sheet, a matte sheet, or a high-quality sheet. A “finished size” refers to the finished size of the printed matter, such as A4 or B4. “Length” and “width” refer to the length and width of the finished size, respectively, and are indicated in units such as a millimeter (mm).

A “standard” refers to a standard of the sheet used for executing the print job, such as a duodecimo. A “number of cuts” refers to the number of sheets produced as a result of cutting a sheet. “Weight” refers to the weight of the sheet, which may be expressed in the basis weight. “Sheet grain” refers to the grain of the sheet, such as longitudinal grain or lateral grain. A “number of copies” refers to the number of copies of the printed matter. A “unit” is a unit of copies, such as a copy, a sheet, or a book.

A “number of colors” refers to the number of colors used in printing, such as one color or four colors. A “mode” refers to a print mode such as single-sided printing or double-sided printing. “Processing” refers to the processing method for the sheets after printing, such as folding, saddle stitching, or perfect binding. A “number of pages” refers to the total number of pages of the printed matter. The items included in the order receipt item data are not limited to those illustrated in FIG. 5, and other items may be included, or some of the items may be omitted.

### Sheet Arrangement Item Data

FIG. 6 is a diagram illustrating an example of the sheet arrangement item data. The sheet arrangement item data is the details of the contents of sheet arrangement including the processing conditions of a print job. The sheet arrangement item data is input and confirmed in the printing staff terminal apparatus 31. The sheet arrangement item data is stored in the sheet arrangement item DB 15a of the arrangement management apparatus 10.

The sheet arrangement item data is associated with one piece of order receipt item data and includes, for example, the items illustrated in FIG. 6. Of these items, for example, a “sheet arrangement ID,” an “order receipt ID,” a “number of sheets,” a “print level,” a “number of additional spare sheets,” and a “number of sheets to be ordered” are automatically input at the time of registration of the print job. An “approval date” is automatically input when the execution of the print job is approved in the manager terminal apparatus 32. The “print level” and the “number of additional spare sheets” may be input or revised by the user.

In FIG. 6, the “sheet arrangement ID” is identification information for uniquely identifying the print job for which the sheet arrangement is requested. The “order receipt ID” is identification information for identifying the order receipt item data associated with the order receipt ID. A “product name” refers to the name of the sheet. The “number of sheets” is the number of sheets required for executing the print job.

The “print level” is an example of the level information indicating the degree of difficulty in executing a print job, and indicates the level according to the degree of difficulty in executing the print job, for example, on a scale of one to ten. For example, the initial value of the print level is set to five, and as the number is larger, the degree of difficulty in execution is considered to be higher. Alternatively, as the number is smaller, the degree of difficulty in execution may be considered to be higher. The “number of additional spare sheets” refers to the number of additional spare sheets in consideration of losses in executing the print job, and is an example of the number of spare sheets.

The “number of sheets to be ordered” refers to the number of sheets that is to be ordered. The “number of sheets to be ordered” may be, for example, the total of the “number of sheets” that is the number of sheets required for executing the print job and the “number of additional spare sheets.” An “order destination” is information that indicates a supplier to which the order for the sheets is placed. An “order date” refers to the date when the order for the sheets is placed. The “approval date” refers to the date when the execution of the print job is approved, and also refers to the date when an arrangement request for the sheets is approved. A “preparation completion date” refers to the date when the preparation of the sheets is completed.

The items included in the sheet arrangement item data are not limited to those illustrated in FIG. 6, and other items may be included, or some of the items may be omitted.

### Screen Transition of Each Terminal Apparatus

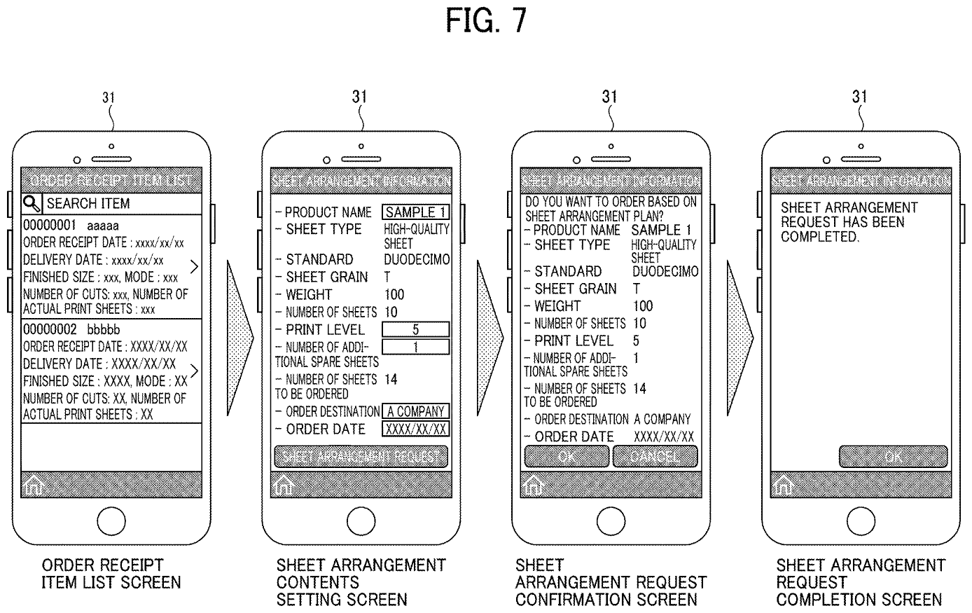

The transitions of screens displayed by the printing staff terminal apparatus 31, the manager terminal apparatus 32, and the cutting staff terminal apparatus 33 and each screen are described below. In the following description, the sheet is also referred to as “paper” or a “sheet of paper.” FIG. 7 is a diagram illustrating transitions of screens displayed by the printing staff terminal apparatus 31 at the time of the sheet arrangement.

The printing staff terminal apparatus 31 displays a list of order receipt items based on the order receipt item data that is an example of the list of print jobs registered, from the sales staff terminal apparatus 34, in the order receipt item management server 20. The list of order receipt items is displayed when the printing staff terminal apparatus 31 accesses the order receipt item management server 20.

The list of order receipt items includes, for example, the order receipt ID, the delivery date, the subject, and the order type of the print job, which are the details of the information on each order receipt item. The printing staff member selects a print job to be executed in the printing staff terminal apparatus 31.

The printing staff terminal apparatus 31 displays a sheet arrangement contents setting screen. The sheet arrangement contents setting screen is a screen for setting the details of the contents of the sheet arrangement. The printing staff member sets at least a part of the processing conditions for the selected print job. More specifically, the printing staff member operates setting by inputting, on the sheet arrangement contents setting screen, items such as the product name, the print level, the number of additional spare sheets, the order destination, and the order date included in the sheet arrangement item data illustrated in FIG. 6. The items input by the printing staff member are not limited to thereto.

The printing staff terminal apparatus 31 displays a sheet arrangement request confirmation screen. The sheet arrangement request confirmation screen is a screen for confirming the contents of the sheet arrangement. On the sheet arrangement request confirmation screen, each item of the sheet arrangement item data for the print job to be executed is displayed. When the displayed contents do not need to be revised, the printing staff member presses an “OK button.” Then, the printing staff terminal apparatus 31 requests the arrangement management apparatus 10 to arrange the sheets to be used for executing the print job. The arrangement request unit 12 of the arrangement management apparatus 10 requests the manager terminal apparatus 32 to arrange the sheets to be used for executing the print job.

The printing staff terminal apparatus 31 displays a sheet arrangement request completion screen. The sheet arrangement request completion screen is a screen for notifying that the request for the sheet arrangement is completed. On the sheet arrangement request completion screen, a message confirming that the request for the sheet arrangement is transmitted as intended is displayed. The printing staff terminal apparatus 31 receives, from the notification unit 13 of the arrangement management apparatus 10, a notification indicating that the request for the sheet arrangement is completed.

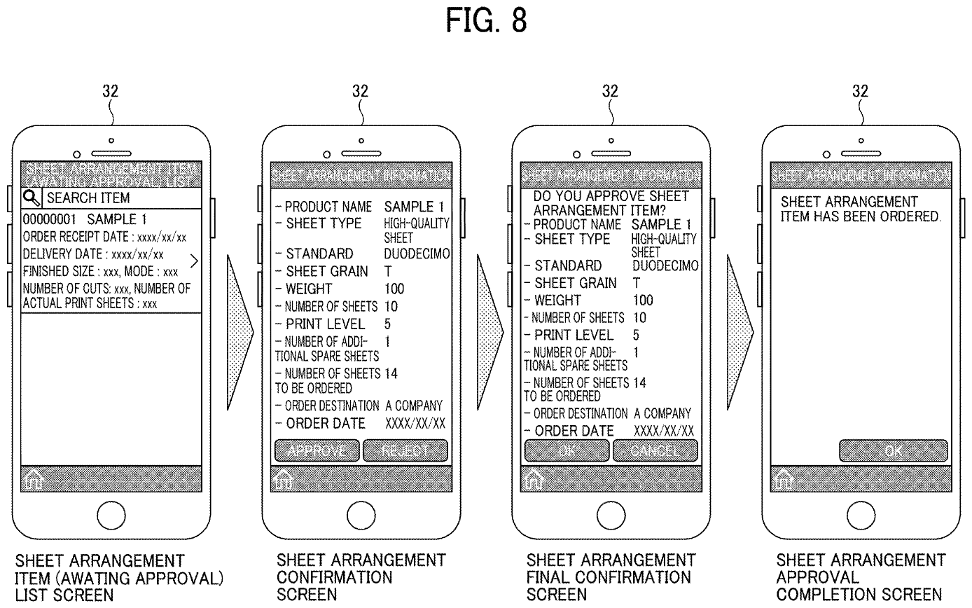

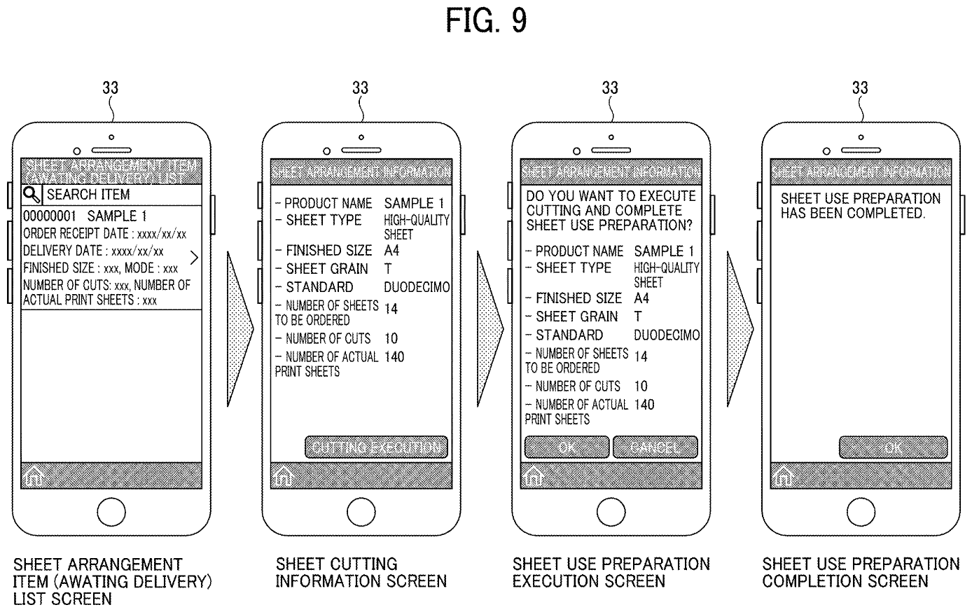

FIG. 8 is a diagram illustrating transitions of screens displayed by the manager terminal apparatus 32 at the time of the sheet arrangement. The manager terminal apparatus 32 displays a sheet arrangement item (awaiting approval) list screen. On the sheet arrangement item (awaiting approval) list screen, a list of print jobs requested to be approved, which are received from the printing staff terminal apparatus 31, is displayed.

On the sheet arrangement item (awaiting approval) list screen, items relating to the print jobs requested to be approved, such as the sheet arrangement ID, the product name, the sheet type, and the standard, are displayed. The manager selects a print job to be approved on the sheet arrangement item (awaiting approval) list screen.

The manager terminal apparatus 32 displays a sheet arrangement confirmation screen. The sheet arrangement confirmation screen is a screen for confirming the contents of the arrangement of sheets. On the sheet arrangement confirmation screen, each item of the sheet arrangement item data for the print job to be executed is displayed. When the displayed contents do not need to be revised, the manager presses an “approval button.” When the manager does not desire to approve the print job, the manager presses a “reject button.”

The manager terminal apparatus 32 displays a sheet arrangement final confirmation screen. On the sheet arrangement final confirmation screen, the same items as those on the sheet arrangement confirmation screen are displayed. The sheet arrangement final confirmation screen is a screen for finally confirming the contents of the arrangement of the sheets. When the content of each displayed item does not need to be revised, the manager presses an “OK button” to approve the execution of the print job. Thus, the sheet arrangement is executed. At this time, the manager terminal apparatus 32 transmits, to the arrangement management apparatus 10, a notification relating to a request for preparing the sheets to be used in executing the print job. The notification unit 13 of the arrangement management apparatus 10 transmits, to the cutting staff terminal apparatus 33, the notification relating to the request for preparing the sheets to be used in executing the print job.

The manager terminal apparatus 32 displays a sheet arrangement approval completion screen. The sheet arrangement approval completion screen is a screen for notifying that the arrangement of the sheets is completed. On the sheet arrangement approval completion screen, a message confirming that the approval for the execution of the print job and the arrangement of the sheets is transmitted as intended is displayed.

FIG. 9 is a diagram illustrating transitions of screens displayed by the cutting staff terminal apparatus 33 at the time of cutting the sheets and preparing the sheets for use. The cutting staff terminal apparatus 33 displays a sheet arrangement item (awaiting delivery) list screen. On the sheet arrangement item (awaiting delivery) list screen, a print job that is approved by the manager terminal apparatus 32 and for which a cutting instruction is issued by the notification unit 13 of the arrangement management apparatus 10 is displayed.

On the sheet arrangement item (awaiting delivery) list screen, items relating to the print job requested to be approved, such as the product name, the sheet type, the finished size, and the standard are displayed. The cutting staff member selects a print job for which sheet cutting is to be executed, on the sheet arrangement item (awaiting delivery) list screen.

The cutting staff terminal apparatus 33 displays a sheet cutting information screen. The sheet cutting information screen is a screen for displaying the details of the information on the print job for which sheet cutting is to be executed. The cutting staff member performs cutting work while checking the details of the information displayed on the sheet cutting information screen. The cutting staff member presses a “cutting execution button” after the cutting work is completed.

The cutting staff terminal apparatus 33 displays a sheet use preparation execution screen. The sheet use preparation execution screen is a screen for executing preparation of the sheets for use. On the sheet use preparation execution screen, the same items as those on the sheet cutting information screen are displayed. The cutting staff member checks the displayed contents. When the displayed contents do not need to be revised, the cutting staff member presses an “OK button” to execute the preparation of the sheets for use. The cutting staff terminal apparatus 33 transmits, to the arrangement management apparatus 10, a notification indicating that the preparation of the sheets for use is completed. The notification unit 13 of the arrangement management apparatus 10 transmits, to the printing staff terminal apparatus 31, the notification indicating that the preparation of the sheets for use is completed.

The cutting staff terminal apparatus 33 displays a sheet use preparation completion screen. The sheet use preparation completion screen is a screen for notifying that the preparation of the sheets for use is completed. On the sheet use preparation completion screen, a message confirming that the preparation of the sheets for use is executed as intended is displayed.

### Processes Performed in Arrangement Management System

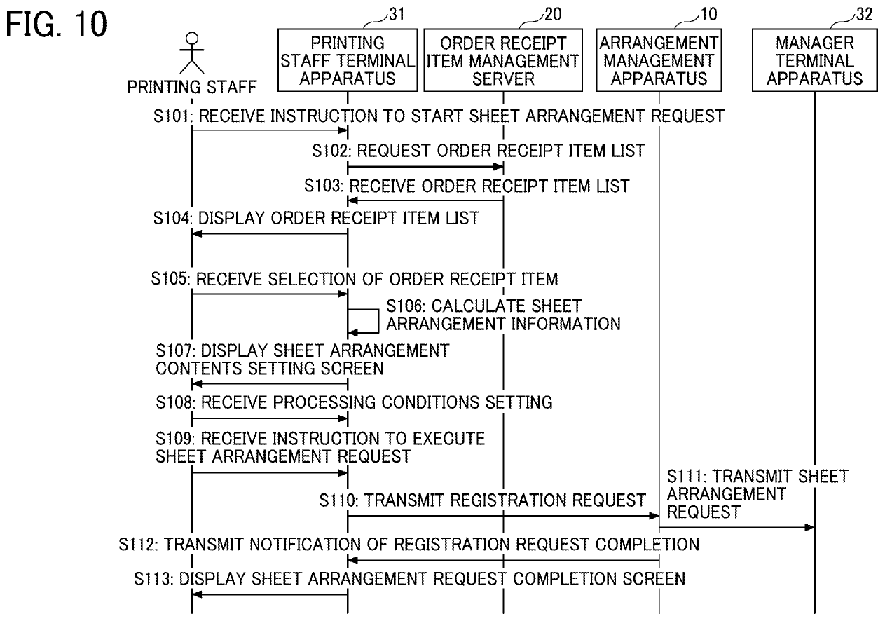

In the following description, the processes to request the sheet arrangement, order the sheets, and prepare the sheets for use are described. FIG. 10 is a sequence diagram illustrating the process to request the sheet arrangement in the arrangement management system 1.

In S101, the printing staff terminal apparatus 31 receives a request for starting the sheet arrangement instructed by the printing staff member on the order receipt item list screen. In S102, the printing staff terminal apparatus 31 transmits a request for acquiring a list of order receipt items to the order receipt item management server 20. In S103, the printing staff terminal apparatus 31 receives a response including the list of order receipt items from the order receipt item management server 20. In S104, the printing staff terminal apparatus 31 displays the list of order receipt items on the screen based on the order receipt item data.

In S105, the printing staff terminal apparatus 31 receives a selection of a print job, which is an order receipt item for which the sheet arrangement is desired to be executed, instructed by the printing staff member on the order receipt item list screen. In S106, the printing staff terminal apparatus 31 calculates paper arrangement information, which is an example of sheet arrangement information. In S107, the printing staff terminal apparatus 31 displays the sheet arrangement contents setting screen.

The sheet arrangement information includes items relating to the selected print job, such as the sheet type, the standard, the sheet grain, the weight, the number of sheets, and the number of sheets to be ordered. Among these items, the sheet type, the standard, the sheet grain, and the weight are acquired from the order receipt item data, and the number of sheets and the number of sheets to be ordered are calculated based on the data of the items included in the sheet arrangement item data.

The number of sheets included in the sheet arrangement information is calculated by, for example, the following Equation (1).

Number of sheets=Number of copies/Number of cuts (1)

The number of sheets to be ordered is calculated by, for example, the following Equation (2).

Number of sheets to be ordered=Number of sheets+Number of sheets×(Print level/20)+Number of additional spare sheets (2)

In S108, the printing staff terminal apparatus 31 receives the processing conditions set and confirmed by the printing staff member on the sheet arrangement contents setting screen. The processing conditions to be set are items of the product name, the print level (1 to 10), the number of additional spare sheets, the order destination, and the order date. These items can be manually input and the contents of the items can be changed. For example, when the print level is set low, the number of additional spare sheets is set to a small number, and when the print level is set high, the number of additional spare sheets is set to a large number.

In S109, the printing staff terminal apparatus 31 receives an instruction operated by the printing staff member on the sheet arrangement request confirmation screen to execute the request for the sheet arrangement. In S110, the printing staff terminal apparatus 31 transmits a registration request to the arrangement management apparatus 10. In S111, the arrangement request unit 12 of the arrangement management apparatus 10 requests the manager terminal apparatus 32 to arrange the sheets based on information such as the number of sheets to be used for the selected print job. The request for arranging the sheets is performed using a method such as an e-mail that is automatically created.

As expressed in Equation (2), since the number of sheets to be ordered is the total of the number of sheets and the number of additional spare sheets calculated based on the print level, the arrangement request unit 12 requests the sheet arrangement based on the print level of each print job and the number of additional spare sheets required for each selected print job.

In S112, the notification unit 13 of the arrangement management apparatus 10 transmits, to the printing staff terminal apparatus 31, a notification indicating that the registration of the sheet arrangement is completed. In S113, the printing staff terminal apparatus 31 displays the sheet arrangement request completion screen. The request for arranging the sheets to the manager terminal apparatus 32 may be transmitted from the printing staff terminal apparatus 31.

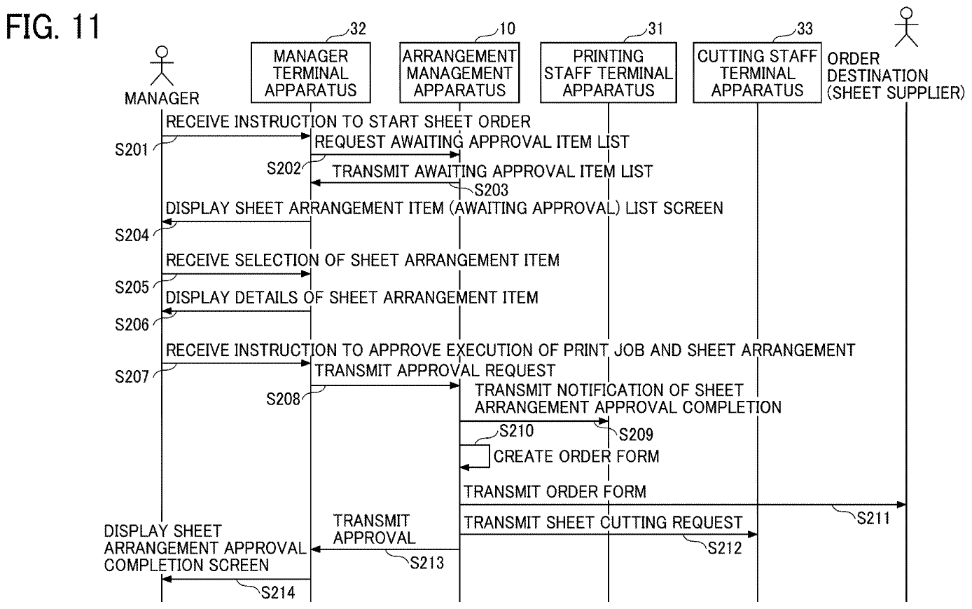

The process to order the sheets is described below. FIG. 11 is a sequence diagram illustrating the process to order the sheets in the arrangement management system 1.

In S201, the manager terminal apparatus 32 starts the order for the sheets in response to an instruction from the manager. In S202, the manager terminal apparatus 32 transmits, to the arrangement management apparatus 10, a request for acquiring a list of awaiting approval items that are transmitted from the printing staff terminal apparatus 31 to the arrangement management apparatus 10 and are print jobs for which the sheet arrangements have been registered. In S203, the arrangement management apparatus 10 transmits, to the manager terminal apparatus 32, a response including the list of awaiting approval items for which the sheet arrangements have been requested. In S204, the manager terminal apparatus 32 displays the sheet arrangement item (awaiting approval) list screen based on the list of awaiting approval items.

In S205, the manager terminal apparatus 32 receives a selection of a print job operated by the manager on the sheet arrangement item (awaiting approval) list screen, for which the sheet arrangement is to be requested. In S206, the manager terminal apparatus 32 displays the sheet arrangement final confirmation screen presenting the details of the selected print job so that the manager can confirm the contents of the sheet arrangement.

In S207, when the content of each displayed item does not need to be revised, the manager terminal apparatus 32 receives an instruction operated by the manager to approve the execution of the print job and the sheet arrangement. In S208, the manager terminal apparatus 32 transmits a request for approving the execution of the print job and the sheet arrangement to the arrangement management apparatus 10. In S209, the arrangement management apparatus 10 transmits, to the printing staff terminal apparatus 31, a notification indicating that the approval for the execution of the print job and the sheet arrangement is completed.

In S210, the arrangement management apparatus 10 creates an order form for the sheets based on the request for approving the execution of the print job and the sheet arrangement received from the manager terminal apparatus 32. The order form for the sheets is created in a format such as a portable document format (PDF) file, but the format is not limited thereto. In S211, the created order form is transmitted to an e-mail address associated with information for identifying a sheet supplier that is the order destination for the sheets. At this time, the arrangement management apparatus 10 records, in the sheet arrangement item data, the date when the order form is transmitted in the item “order date.” In S212, the arrangement management apparatus 10 transmits, to the cutting staff terminal apparatus 33 by, for example, an e-mail, a request for sheet cutting, which is a notification relating to a request for preparing the sheets used for executing the print job.

When the processes of steps S209 to S212 are executed, in S213, the arrangement management apparatus 10 transmits a response to the request to the manager terminal apparatus 32. In S214, the manager terminal apparatus 32 displays the sheet arrangement approval completion screen notifying that the sheet arrangement is completed. The manager terminal apparatus 32 may perform the creation and transmission of the order form.

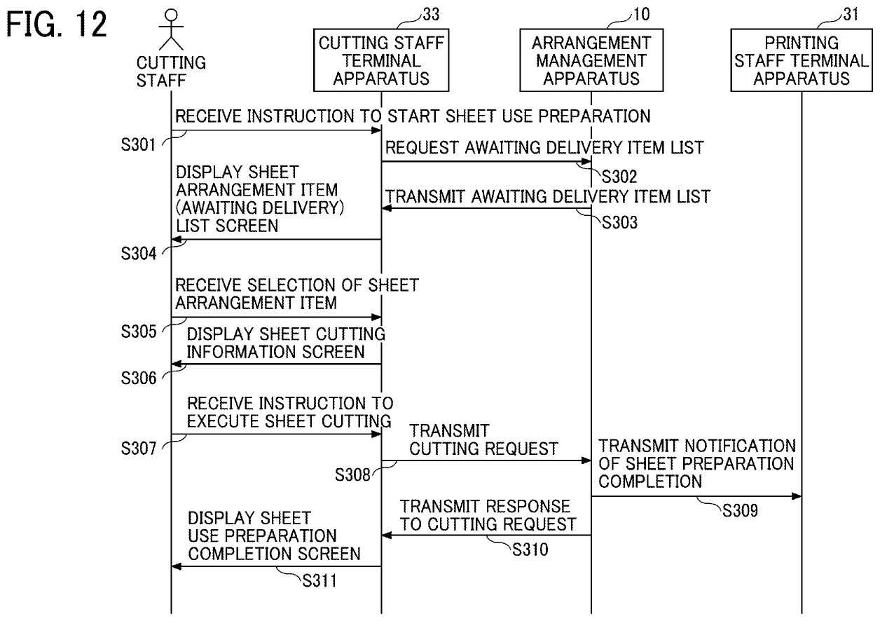

The process to prepare the sheets for use is described below. FIG. 12 is a sequence diagram illustrating the process to prepare the sheets for use in the arrangement management system 1.

In S301, the cutting staff terminal apparatus 33 starts preparation of the sheets for use in response to an instruction from the manager. In S302, the cutting staff terminal apparatus 33 transmits, to the arrangement management apparatus 10, a request for acquiring a list of awaiting delivery items, which are print jobs whose execution is approved in the manager terminal apparatus 32. In S303, the arrangement management apparatus 10 transmits a response including the list of awaiting delivery items to the cutting staff terminal apparatus 33. In S304, the manager terminal apparatus 32 displays the sheet arrangement item (awaiting delivery) list screen based on the list of awaiting delivery items.

In S305, the cutting staff terminal apparatus 33 receives a selection of a print job operated by the cutting staff member on the sheet arrangement item (awaiting delivery) list screen, which is a sheet arrangement item for which sheet cutting is to be executed. In S306, the cutting staff terminal apparatus 33 displays the sheet cutting information screen including the details of information on the print job for which the sheet cutting is to be executed. In S307, the cutting staff member instructs, while checking the displayed details of the information on the print job, the cutting staff terminal apparatus 33 to perform cutting work.

When the cutting staff member completes the instruction to perform the sheet cutting, the cutting staff terminal apparatus 33 receives an instruction to executes the sheet cutting from the cutting staff member. The cutting staff terminal apparatus 33 displays the sheet use preparation execution screen, which is a screen for performing preparation of the sheets for use. In S308, in response to an operation performed by the cutting staff member on the sheet use preparation execution screen, the cutting staff terminal apparatus 33 transmits a request for cutting the sheets to the arrangement management apparatus 10. At this time, the arrangement management apparatus 10 records, in the sheet arrangement item data, the date when the request for the sheet cutting is transmitted in the item “preparation completion date.” In S309, the arrangement management apparatus 10 transmits, to the printing staff terminal apparatus 31 by, for example, an e-mail, a notification indicating that the preparation of the sheets for use is completed. By receiving the notification indicating that the preparation of the sheets for use is completed, the printing staff member can confirm the order receipt ID of the print job for which printing work can be started.

In S310, the communication unit 14 of the arrangement management apparatus 10 transmits a response to the request for the sheet cutting to the cutting staff terminal apparatus 33. In S311, the cutting staff terminal apparatus 33 displays the sheet use preparation completion screen, which is a screen notifying that the preparation of the sheets for use is completed. The cutting staff terminal apparatus 33 may perform the transmission of the notification indicating that the preparation of the sheets for use is completed to the printing staff terminal apparatus 31.

### Arrangement Management Method

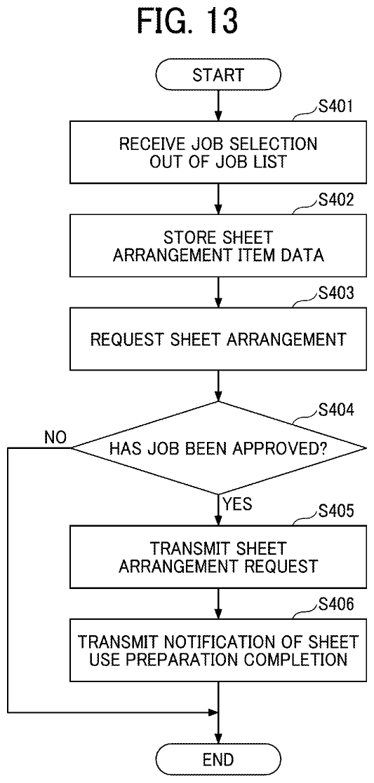

FIG. 13 is a flowchart of an arrangement management method performed by the arrangement management apparatus 10. It is assumed that, in the order receipt item management server 20, the job information of the print job received from the sales staff terminal apparatus 34, for which the order has been received, is already input, and the order receipt item data, which is an example of the list of print jobs, is stored.

In S401, the reception unit 11 of the arrangement management apparatus 10 receives a selection of a print job from the list of print jobs, which is the order receipt item data, displayed on the printing staff terminal apparatus 31 and at least a part of the settings of the processing conditions for the selected print job.

In S402, the storage unit 15 of the arrangement management apparatus 10 stores the sheet arrangement item data including items relating to at least a part of the settings of the processing conditions for the selected print job. At least a part of the settings of the processing conditions received by the reception unit 11 are items such as the product name, the print level, the number of additional spare sheets, the order destination, and the order date included in the sheet arrangement item data illustrated in FIG. 6.

After receiving the selection of the print job, in S403, the arrangement request unit 12 of the arrangement management apparatus 10 requests the manager terminal apparatus 32 to arrange the sheets used for the execution of the print job.

In S404, the manager terminal apparatus 32 determines whether the execution of the print job has been approved. In the case where the manager terminal apparatus 32 determines that the execution of the print job has been approved (YES in S404), in S405, the notification unit 13 of the arrangement management apparatus 10 transmits a notification relating to the request for preparing the sheets to be used for the execution of the print job to the cutting staff terminal apparatus 33. The notification relating to the request for preparing the sheets includes, for example, an instruction to cut the sheets.

When the notification unit 13 receives the request for the sheet cutting from the cutting staff terminal apparatus 33 and the preparation of the sheets for use is completed, in S406, the notification unit 13 transmits a notification indicating that the preparation of the sheets for use is completed to the printing staff terminal apparatus 31. Then, the processes end. In the case where the manager terminal apparatus 32 determines that the execution of the print job has not been approved (NO in S404), the processes end without any other process being performed. When the processes described above end, the print job is executed.

The arrangement management method according to one aspect of the present disclosure is performed by these steps. However, the arrangement management according to one aspect of the present disclosure may include other steps as appropriate depending on, for example, measurement conditions or measurement environments.

The state of sheets used for a print job changes under the influence of the environment such as temperature and humidity in a storage place. According to the technique in the art, the inventory information indicating whether the sheets are in stock is displayed, but it is assumed that the sheets are prepared in stock in advance when a print job is executed. Since the environment of the storage place for the sheets needs to be kept in an appropriate state, it is difficult to reduce the workload of inventory management of the sheets used for the print job in the work environment.

According to one aspect of the present disclosure, after receiving a selection of a job, the arrangement management apparatus 10 requests the arrangement of the materials used for the execution of the job and notifies the completion of the preparation of the materials for use. The arrangement management apparatus 10 executes the job using the materials after the preparation of the materials for use is completed. Thus, the workload of preparing various types of sheets in advance according to, for example, the type of an expected print job and managing the temperature and humidity of a storage place for the sheets is reduced.

Accordingly, according to the arrangement management apparatus 10 of the present embodiment, the workload of the inventory management of the sheets used for the print job according to the working environment is reduced.

### Another Embodiment

The arrangement management system 1 according to the present embodiment described above is a system for managing arrangement of sheets in a working environment where a print job is executed. In the following description, another applied case of the arrangement management system 1 according to the present embodiment is described.

The arrangement management system 1 is also applicable to a system for managing arrangement of steel plates to be used for jobs including cutting of the steel plates in a work environment where cutting, shape correction, and forming of parts are performed on the steel plates. In the working environment, steel plates and steel plate components which are cut and processed and used in, for example, automobiles, home electric appliances, or building materials, are manufactured, and the steel plates before being cut are stored.

After receiving a selection of a job such as cutting of steel plates, the arrangement management system 1 requests the arrangement of the steel plates to be used for the execution of the job and notifies the completion of the preparation of the steel palates for use. Accordingly, the workload of preparing a large amount of steel plates in large size according to the type of a job such as cutting of steel plates, which is assumed to be performed for the job using the steel plates, is reduced.

In particular, the arrangement management system 1 is effectively used in the work environment where cutting of steel plates is performed, because the work yard is narrow, the ambient temperature is high due to the surrounding equipment heated by high-temperature cast slabs, and the occurrence of accidents such as the pinching of hands or fingers during manual work is concerned.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

Aspects of the present disclosure are, for example, as follows.

According to Aspect 1, an arrangement management apparatus includes a reception unit that receives, from a first terminal apparatus, a selection of a job from a list of jobs for producing products displayed on the first terminal apparatus and at least a part of settings of processing conditions for the selected job, an arrangement request unit that requests, after the selection of the job is received, a second terminal apparatus to arrange a material used for executing the job, and a notification unit that transmits, to the first terminal apparatus, a notification indicating that the preparation of the material for use is completed.

According to Aspect 2, in the arrangement management apparatus of Aspect 1, the notification unit transmits, when an approval for executing the job is received from the second terminal apparatus, a notification relating to a request for preparing the material used for executing the job to a third terminal apparatus.

According to Aspect 3, in the arrangement management apparatus of Aspect 1 or 2, the arrangement request unit requests arrangement of the material based on information relating to the quantity of the material used for the selected job.

According to Aspect 4, in the arrangement management apparatus of any one of Aspects 1 to 3, the arrangement request unit requests the arrangement of the material based on level information included in the processing conditions and indicating a degree of difficulty of execution for each of the jobs and a spare quantity of the material required for each job selected from the jobs.

According to Aspect 5, in the arrangement management apparatus of Aspect 4, the spare quantity of the material required for the job is a quantity determined based on the level information of the job.

According to Aspect 6, in the arrangement management apparatus of any one of Aspects 1 to 5, the list of jobs is information generated based on data generated based on information on the jobs input from a fourth terminal apparatus.

According to Aspect 7, in the arrangement management apparatus of any one of Aspects 1 to 6, the job is a print job, and the material used for executing the job is a sheet on which an image is to be printed.

According to Aspect 8, an arrangement management method performed by an arrangement management apparatus includes receiving, from a first terminal apparatus, a selection of a job operated by a user from a list of jobs for producing products displayed on the first terminal apparatus and at least a part of settings of processing conditions for the selected job, requesting, after the selection of the job is received, a second terminal apparatus to arrange a material used for executing the job, and transmitting, to the first terminal apparatus, a notification indicating that the preparation of the material for use is completed.

According to Aspect 9, a non-transitory recording medium stores a plurality of program codes which, when executed by one or more processors on an arrangement management apparatus, causes the one or more processors to perform a method including receiving, from a first terminal apparatus, a selection of a job operated by a user from a list of jobs for producing products displayed on the first terminal apparatus and at least a part of settings of processing conditions for the selected job, requesting, after the selection of the job is received, a second terminal apparatus to arrange a material used for executing the job, and transmitting, to the first terminal apparatus, a notification indicating that the preparation of the material for use is completed.

1. An arrangement management apparatus comprising circuitry configured to:
receive, from a first terminal apparatus, a selection of a job from a list of a plurality of jobs being displayed on the first terminal apparatus, each job for producing products and at least a part of settings of processing conditions for the selected job;
request, after the selection of the job is received, a second terminal apparatus to arrange a material used for executing the job; and
transmit, to the first terminal apparatus, a notification indicating that preparation of the material for use is completed.

2. The arrangement management apparatus according to claim 1, wherein, in a case that an approval for executing the job is received from the second terminal apparatus, the circuitry is configured to transmit another notification relating to a request for preparing the material used for executing the job to a third terminal apparatus.

3. The arrangement management apparatus according to claim 1, wherein the circuitry is configured to request the arrangement of the material based on information relating to a quantity of the material used for the job.

4. The arrangement management apparatus according to claim 1, wherein, the selected job includes a plurality of selected jobs, and the circuitry is configured to request the arrangement of the material based on level information included in the processing conditions and indicating a degree of difficulty in executing the job for each of the plurality of selected jobs and a spare quantity of the material required for each of the plurality of selected jobs.

5. The arrangement management apparatus according to claim 4, wherein the spare quantity of the material required for the selected job is a quantity determined based on the level information of the selected job.

6. The arrangement management apparatus according to claim 1, wherein the list of the plurality of jobs is generated based on information on the plurality of jobs input from a fourth terminal apparatus.

7. The arrangement management apparatus according to claim 1, wherein:
the job is a print job; and
the material is a sheet on which an image is to be printed.

8. An arrangement management method, comprising:
receiving, from a first terminal apparatus, a selection of a job from a list of a plurality of jobs being displayed on the first terminal apparatus, each job for producing products and at least a part of settings of processing conditions for the selected job;
requesting, after the selection of the job is received, a second terminal apparatus to arrange a material used for executing the job; and
transmitting, to the first terminal apparatus, a notification indicating that preparation of the material for use is completed.

9. A non-transitory recording medium storing a plurality of program codes which, when executed by one or more processors, causes the one or more processors to perform a method, the method comprising:
receiving, from a first terminal apparatus, a selection of a job from a list of a plurality of jobs being displayed on the first terminal apparatus, each job for producing products and at least a part of settings of processing conditions for the selected job;
requesting, after the selection of the job is received, a second terminal apparatus to arrange a material used for executing the job; and
transmitting, to the first terminal apparatus, a notification indicating that preparation of the material for use is completed.
